(19) United States
(12) Patent Application Publication
(10) Pub. No.: US 2018/0274461 A1
(43) Pub. Date: Sep. 27, 2018

(54) TURBOCHARGED ENGINE CONTROL DEVICE

(71) Applicant: MAZDA MOTOR CORPORATION, Hiroshima (JP)

(72) Inventors: Kenko UJIHARA, Higashihiroshima-shi, Hiroshima (JP); Hiroaki SHIIBA, Aki-gun, Hiroshima (JP); Toshiya KAN, Aki-gun, Hiroshima (JP)

(73) Assignee: MAZDA MOTOR CORPORATION, Hiroshima (JP)

(21) Appl. No.: 15/762,485

(22) PCT Filed: Oct. 14, 2016
(86) PCT No.: PCT/JP2016/080583

§ 371 Date: Mar. 22, 2018

(30) Foreign Application Priority Data
Oct. 30, 2015 (JP) 2015-214612

(51) Int. Cl. F02D 23/02; F02D 33/00; F02D 43/04; F02P 5/15; F02D 41/00; B60W 30/045; B60W 30/18

(52) U.S. Cl. CPC F02D 23/02; B60W 2710/0633; F02D 43/04; F02P 5/1502; F02D 41/0007; B60W 30/045; B60W 30/18145; F02D 2200/1002; F02D 2200/60; F02D 2250/18; B60W 2540/18; B60W 2710/0666; B60W 2720/12; B60W 2540/10; B60W 2710/0627; F02D 33/003

(57) ABSTRACT

Provided is a turbocharged engine control device capable of controlling an engine to accurately realize vehicle behavior intended by a driver, while suppressing deterioration in acceleration response. The turbocharged engine control device comprises: a basic target torque-determining part (61) configured to determine a basic target torque based on a driving state of a vehicle including manipulation of an accelerator pedal; a torque reduction amount-determining part (63) configured to determine a torque reduction amount based on a driving state of the vehicle other than the manipulation of the accelerator pedal; a final target torque-determining part (65) configured to determine a final target torque based on the basic target torque and the torque reduction amount; and an engine control part (69) configured to control the engine to output the final target torque, while controlling the turbocharger based on the final target torque, wherein the engine control part (69) is configured to restrict controlling the turbocharger (5) according to a change in the final target torque corresponding to a change in the torque reduction amount.

### TECHNICAL FIELD

The present invention relates to a turbocharged engine control device, and more particularly to a turbocharged engine control device for controlling an engine comprising at least a turbocharger, based on a driving state of a vehicle mounting the engine.

### BACKGROUND ART

Heretofore, there has been known a control device capable of, in a situation where the behavior of a vehicle becomes unstable due to road wheel slip or the like, controlling the vehicle behavior to enable a safe traveling (e.g., an antiskid brake device). Specifically, there has been known a control device operable to detect the occurrence of vehicle understeer or oversteer behavior during vehicle cornering or the like, and apply an appropriate degree of deceleration to one or more road wheels so as to suppress such behavior.

There has also been known a vehicle motion control device operable to adjust a degree of deceleration during vehicle cornering to thereby adjust a load to be applied to front road wheels as steerable road wheels so as to enable a series of manipulations (braking, turning of a steering wheel, accelerating, turning-back of the steering wheel, etc.) by a driver during vehicle cornering under a normal traveling condition to be performed naturally and stably, differently from the aforementioned control for improving safety in a traveling condition causing the vehicle behavior to become unstable (see, for example, the following Patent Document 1).

Further, there has been proposed a vehicle behavior control device operable to reduce a vehicle driving force according to a yaw rate-related quantity (e.g., yaw acceleration) corresponding to steering wheel manipulation by a driver, thereby making it possible to quickly generate vehicle deceleration in response to start of the steering wheel manipulation by the driver and thus quickly apply a sufficient load to front road wheels as steerable road wheels (see, for example, the following Patent Document 2). In this vehicle behavior control device, in response to start of the steering wheel manipulation, a load is quickly applied to the front road wheels to cause an increase in frictional force between each of the front road wheels and a road surface and thus an increase in cornering force of the front road wheels, thereby providing an improved turn-in ability of a vehicle in an initial phase after entering a curve, and an improved responsivity with respect to turning manipulation of a steering wheel. This makes it possible to realize vehicle behavior just as intended by the driver.

### CITATION LIST

### Patent Document

Patent Document 1: JP 2011-88576A
Patent Document 2: JP 2014-166014A

### SUMMARY OF INVENTION

### Technical Problem

In the field of internal combustion engines such as a gasoline engine and a diesel engine, there has been known a technique of providing a turbocharger with a view to improving engine power output, and controlling a supercharging pressure of the turbocharger according to a target torque determined based on a driving state of a vehicle (e.g., manipulation states of various devices such as an accelerator pedal, a brake pedal and a steering wheel by a driver, and traveling environments such as vehicle speed, ambient temperature, atmospheric pressure, road grade and road surface mu (μ)).

Assume that, in such an engine control device for an engine comprising a turbocharger, a current target torque is instantaneously changed by the vehicle behavior control device described in the Patent Document 2, so as to generate vehicle deceleration according to manipulation of a steering wheel by a driver. In this case, the turbocharger will be controlled to realize the changed target torque. That is, the engine control device operates to control the turbocharger to change the supercharging pressure according to a change in target torque.

However, when a current target torque is instantaneously reduced so as to generate vehicle deceleration, the turbocharger is controlled to lower the supercharging pressure according to the reduction in target torque. Thus, after that, when the reduced target torque is instantaneously raised, a rise in supercharging pressure cannot catch up with the rise in the target torque, causing deterioration in acceleration response.

The present invention has been made to solve the above conventional problem, and an object thereof is to provide a turbocharged engine control device capable of controlling an engine to accurately realize vehicle behavior intended by a driver, while suppressing deterioration in acceleration response.

### Solution to Technical Problem

In order to achieve the above object, the present invention provides a turbocharged engine control device for controlling an engine comprising at least a turbocharger, based on a driving state of a vehicle mounting the engine. The turbocharged engine control device comprises: a basic target torque-determining part configured to determine a basic target torque based on a driving state of the vehicle including manipulation of an accelerator pedal; a torque reduction amount-determining part configured to determine a torque reduction amount based on a driving state of the vehicle other than the manipulation of the accelerator pedal; a final target torque-determining part configured to determine a final target torque based on the basic target torque and the torque reduction amount; and an engine control part configured to control the engine to output the final target torque and control the turbocharger based on the final target torque, wherein the engine control part is configured to restrict controlling the turbocharger according to a change in the final target torque corresponding to a change in the torque reduction amount.

In the turbocharged engine control device of the present invention having the above feature, the engine control part is configured to control the engine to output a final target torque reflecting a torque reduction amount determined based on the vehicle driving state other than the manipulation of the accelerator pedal, so that it is possible to control the engine to obtain the torque reduction amount with high responsivity with respect to the vehicle driving state other than the manipulation of the accelerator pedal, to thereby quickly apply a load to front road wheels. This makes it possible to control the engine to accurately realize vehicle behavior intended by a driver.

Further, the engine control part is configured to restrict controlling the turbocharger according to a change in the final target torque corresponding to a change in the torque reduction amount, so that it is possible to prevent a situation where a supercharging pressure is lowered by controlling the turbocharger according to an instantaneous change in the final target torque directly or fully reflecting the torque reduction amount. Thus, after that, when the reduced target torque is instantaneously raised, it is possible to cause a rise in the supercharging pressure with high responsivity with respect to the rise in the target torque. This makes it possible to suppress deterioration in acceleration response.

Preferably, in the turbocharged engine control device of the present invention, the engine control part is configured to control the turbocharger based on a state of the engine in which the engine is operated to output the basic target torque.

According to this feature, the engine control part is configured to control the turbocharger based on the basic target torque which does not reflect the torque reduction amount, so that it is possible to prevent the situation where the supercharging pressure is lowered by controlling the turbocharger according to an instantaneous change in the final target torque reflecting the torque reduction amount, and thus suppress deterioration in acceleration response.

Preferably, in the turbocharged engine control device of the present invention, the torque reduction amount-determining part is configured to determine the torque reduction amount according to manipulation of a steering wheel of the vehicle.

According to this feature, a temporal change in torque reduction amount determined based on the manipulation of the steering wheel can be reflected on a temporal change in final target torque, so that it is possible to quickly add, to the vehicle, deceleration according to the manipulation of the steering wheel by a driver to thereby apply a load to front road wheels to quickly increase a cornering force, thereby improving responsivity with respect to the manipulation of the steering wheel. This makes it possible to control the engine to accurately realize vehicle behavior intended by the driver, while suppressing deterioration in acceleration response.

In the above turbocharged engine control device, the torque reduction amount-determining part is configured to determine the torque reduction amount such that, as a steering speed of the vehicle becomes larger, the torque reduction amount is gradually increased, and an increase rate of the torque reduction amount is gradually reduced.

According to this feature, when the steering speed of the vehicle starts increasing after start of steering of the vehicle, the torque reduction amount can be quickly increased, so that it is possible to quickly add deceleration to the vehicle at the start of steering of the vehicle to quickly apply a sufficient load to front road wheels as steerable road wheels. This can cause an increase in frictional force between each of the front road wheels as steerable road wheels and a road surface and thus an increase in cornering force of the front road wheels, thereby providing an improved turn-in ability of the vehicle in an initial phase after entering a curve, and an improved responsivity with respect to turning manipulation of the steering wheel, while suppressing deterioration in acceleration response.

Preferably, in the turbocharged engine control device of the present invention, the basic target torque-determining part is configured to determine a target acceleration of the vehicle based on the driving state of the vehicle including the manipulation of the accelerator pedal, and then determine the basic target torque based on the target acceleration.

According to this feature, the basic target torque is determined based on the target acceleration, so that it becomes possible to control the engine to accurately realize acceleration intended by a driver, while suppressing deterioration in acceleration response.

In the turbocharged engine control device of the present invention, when the engine is a diesel engine comprising a fuel injection device for injecting fuel into a cylinder, the engine control part is preferably configured to control the fuel injection device to regulate a fuel injection amount so as to enable the diesel engine to output the final target torque.

According to this feature, by changing the fuel injection amount of the diesel engine according to a final target torque reflecting the torque reduction amount, it becomes possible to accurately realize a temporal change in torque reduction amount determined based on the vehicle driving state other than the manipulation of the accelerator pedal, with high responsivity. This makes it possible to control the diesel engine to accurately realize vehicle behavior intended by a driver.

In the turbocharged engine control device of the present invention, when the engine is a gasoline engine comprising an air-amount regulating device for regulating an air amount to be introduced into a cylinder, and an ignition device for igniting an air-fuel mixture in the cylinder, the engine control part is preferably configured to control the air-amount regulating device to regulate the air amount to be introduced into the cylinder and/or control the ignition device to regulate an ignition timing, so as to enable the gasoline engine to output the final target torque.

According to this feature, by changing the air amount to be introduced into the cylinder and/or the ignition timing, it becomes possible to accurately realize a temporal change in torque reduction amount determined based on the vehicle driving state other than the manipulation of the accelerator pedal, with high responsivity. This makes it possible to control the gasoline engine to accurately realize vehicle behavior intended by a driver.

### Effect of Invention

The turbocharged engine control device of the present invention is capable of controlling an engine to accurately realize vehicle behavior intended by a driver, while suppressing deterioration in acceleration response.

### BRIEF DESCRIPTION OF DRAWINGS

FIG. 1 is a schematic diagram depicting a configuration of an engine employing a turbocharged engine control device according to one embodiment of the present invention.

FIG. 2 is a block diagram depicting an electrical configuration of the turbocharged engine control device according to this embodiment.

FIG. 3 is a flowchart of an engine control processing routine to be executed by the turbocharged engine control device according to this embodiment, so as to control the engine.

FIG. 4 is a flowchart of a torque reduction amount determination processing subroutine to be executed by the turbocharged engine control device according to this embodiment, so as to determine a torque reduction amount.

FIG. 5 is a map presenting a relationship between steering speed, and target additional deceleration to be determined by the turbocharged engine control device according to this embodiment.

FIG. 6 is a map conceptually presenting engine operation regions to be used by the turbocharged engine control device according to this embodiment, as criteria for switching among a plurality of supercharging modes using a large turbocharger and a small turbocharger.

FIG. 7 presents a temporal change in each parameter regarding engine control to be performed by the turbocharged engine control device according to this embodiment during turning of a vehicle equipped with this turbocharged engine control device, wherein: chart (a) is a top plan view schematically depicting the vehicle which is turning in a clockwise direction; chart (b) is a time chart presenting a change in steering angle of the vehicle which is turning in the clockwise direction as depicted in chart (a); chart (c) a time chart presenting a change in steering speed of the vehicle which is turning in the clockwise direction as depicted in chart (a); chart (d) is a time chart presenting a change in additional deceleration determined based on the steering speed presented in chart (c); chart (e) is a time chart presenting a change in torque reduction amount determined based on the additional deceleration presented in chart (d); chart (f) is a time chart presenting changes in basic target torque before and after being smoothed by a torque-variation filter; chart (g) is a time chart presenting a change in fuel injection-controlling final target torque determined based on the basic target torque and the torque reduction amount; chart (h) is a time chart presenting a change in EGR and turbocharger-controlling final target torque determined based on the basic target torque; chart (i) is a time chart presenting a change in required injection amount determined based on the fuel injection-controlling final target torque; chart (j) is a time chart presenting a change in target supercharging pressure determined based on the EGR and turbocharger-controlling final target torque; chart (k) is a time chart presenting a change in instruction duty value for an actuator of a waste gate valve, in the case where the target supercharging pressure changes as presented in chart (j); chart (l) is a time chart presenting a change in target opening degree of a regulator value in the case where the target supercharging pressure changes as presented in chart (j); and chart (m) is a time chart presenting a change in yaw rate (actual yaw rate) generated in the vehicle when the fuel injection amount is controlled as presented in chart (i), and a change in actual yaw rate generated in the vehicle when the control of the fuel injection amount based on the torque reduction amount determined by a torque reduction amount-determining part is not performed.

### DESCRIPTION OF EMBODIMENTS

With reference to the accompanying drawings, a turbocharged engine control device of the present invention will now be described based on an embodiment thereof.

### <System Configuration>

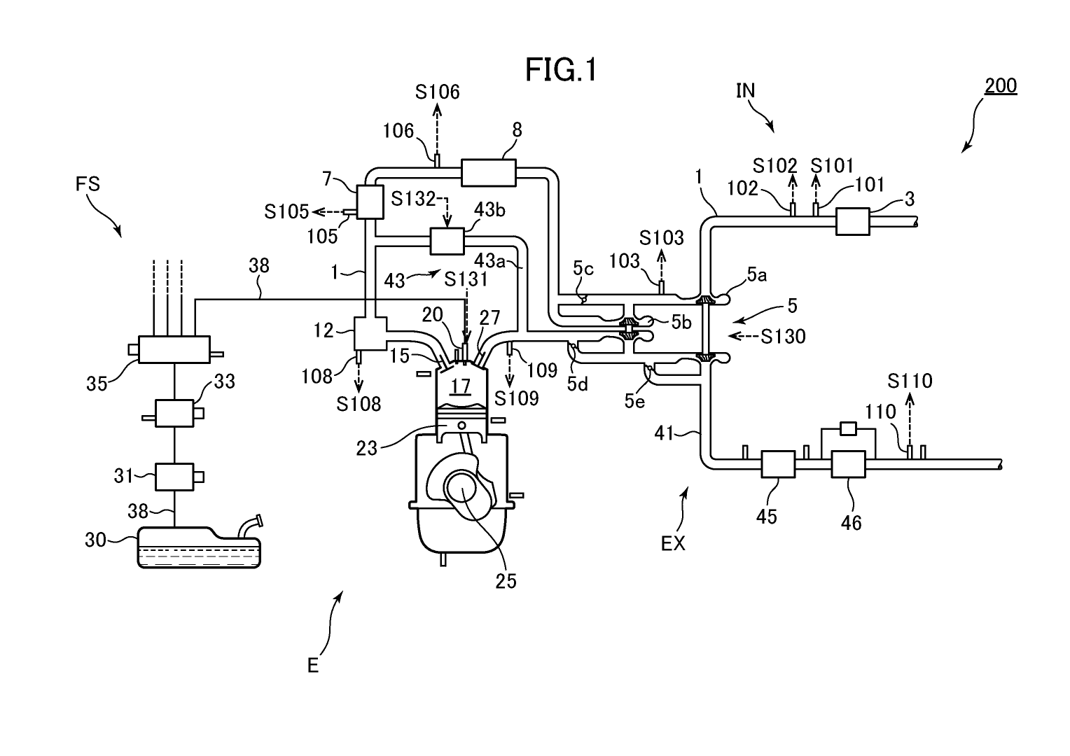

First of all, an engine system employing a turbocharged engine control device according to one embodiment of the present invention will be described with reference to FIG. 1. FIG. 1 is a schematic diagram depicting a configuration of the engine system employing the turbocharged engine control device according to this embodiment.

As depicted in FIG. 1, the engine 200 primarily comprises: an engine (internal combustion engine) body E designed as a diesel engine; an intake system IN for supplying intake air to the engine body E; a fuel supply system FS for supplying fuel to the engine body E; an exhaust system EX for discharging exhaust gas from the engine body E; aftermentioned various sensors 96 to 110 for detecting various states pertaining to the engine 200; and a power-train control module (PCM) 60 for controlling the engine 200.

First, the intake system IN comprises an intake passage 1 for allowing intake air to pass therethrough. The intake passage 1 is provided with: an air cleaner 3 for cleaning intake air introduced from outside; a compressor constituting a turbocharger 5 and configured to compress intake air passing therethrough to cause a rise in intake pressure; an intercooler 8 for cooling intake air by external air or cooling water; an intake shutter valve 7 for regulating a flow volume of intake air passing therethrough; and a surge tank 12 for temporarily storing intake air to be supplied to the engine body E, which are arranged in this order from the side of an upstream end of the intake passage 1.

Further, in the intake system IN, the intake passage 1 is provided with: an airflow sensor 101 for detecting an intake air amount at a position immediately downstream of the air cleaner 3; an intake air temperature sensor 102 for detecting an intake air temperature at the position immediately downstream of the air cleaner 3; an intake air pressure sensor 103 for detecting an intake air pressure inside the turbocharger 5; and an intake air temperature sensor 106 for detecting the intake air temperature at a position immediately downstream of the intercooler 8. Further, the intake shutter value 7 is provided with an intake shutter valve position sensor 105 for detecting an opening degree of the intake shutter valve 7, and the surge tank 12 is provided with an intake air pressure sensor 108 for detecting the intake air pressure in an intake manifold. These various sensors 101 to 108 provided in the intake system IN are operable to output, to the PCM 60, detection signals S101 to S108 corresponding to respective ones of the detected parameter values.

Second, the engine body E is provided with: an intake valve 15 for selectively introducing intake air supplied from the intake passage 1 (specifically, the intake manifold) into a combustion chamber 17 thereof; a fuel injection valve 20 for injecting fuel toward the combustion chamber 17; a piston 23 reciprocatingly movable according to combustion of an air-fuel mixture in the combustion chamber 17; a crankshaft 25 configured to be rotated according to the reciprocating movement of the piston 23; and an exhaust valve 27 for selectively discharging, to an aftermentioned exhaust passage 41, exhaust gas produced by the combustion of the air-fuel mixture in the combustion chamber 17.

Third, the fuel supply system FS comprises a fuel tank 30 for storing fuel therein, and a fuel supply passage 38 for supplying the fuel from the fuel tank 30 to the fuel injection valve 20. The fuel supply passage 38 is provided with a low-pressure fuel pump 31, a high-pressure fuel pump 33, and a fuel injection common rail 35, which are arranged in this order from an upstream end of the fuel supply passage 38.

Fourth, the exhaust system EX comprises an exhaust passage 41 for allowing exhaust gas to pass therethrough. The exhaust passage 41 is provided with: a turbine constituting the turbocharger 5 and configured to be rotated by exhaust gas passing therethrough, so as to rotationally drive the compressor in the aforementioned manner; and a diesel oxidation catalyst (DOC) 45 and a diesel particulate filter (DPF) 46 having an exhaust gas purification function, which are arranged in this order from the side of an upstream end of the exhaust passage 41. The DOC 45 is a catalyst capable of oxidizing hydrocarbon (HC) and carbon monoxide (CO) by using oxygen contained in exhaust gas to thereby convert them into water and carbon dioxide, and the DPF 46 is a filter capable of capturing particulate matter (PM) contained in exhaust gas.

Further, in the exhaust system EX, the exhaust passage 41 is provided with: an exhaust gas pressure sensor 109 for detecting an exhaust gas pressure at a position upstream of the turbine of the turbocharger 5; and a linear O₂ sensor 110 for detecting an oxygen concentration at a position immediately downstream of the DPF 46. These sensors 109, 110 provided in the exhaust system EX are operable to output, to the PCM 60, detection signals S109, S110 corresponding to respective ones of the detected parameter values.

Further, in this embodiment, the turbocharger 5 is constructed as a two-stage supercharging system capable of efficiently obtaining high supercharging in the entire engine speed range from a low engine speed range having relatively low exhaust energy to a high engine speed range. More specifically, the turbocharger 5 comprises: a large turbocharger 5a for supercharging a large amount of air in the high engine speed range; and a small turbocharger 5b capable of efficiently performing supercharging even under relatively low exhaust energy; a compressor bypass valve 5c for controlling a flow of intake air to a compressor of the small turbocharger 5b; a regulator valve 5d for controlling a flow of exhaust gas to a turbine of the small turbocharger 5b; and a waste gate valve 5e for controlling a flow of exhaust gas to a turbine of the large turbocharger 5a. These valves are configured to be driven according to an operation state of the engine body E (engine speed and engine load), so as to switch among a plurality of supercharging modes using the large turbocharger 5a and the small turbocharger 5b.

The engine 200 in this embodiment further comprises an EGR device 43. The EGR device 43 comprises: an EGR passage 43a connecting an area of the exhaust passage 42 upstream of the turbine of the turbocharger 5 to an area of the intake passage 1 downstream of the compressor of the turbocharger 5 (specifically, downstream of the intercooler 8); and an EGR valve 43b for adjusting a flow volume of exhaust gas to be allowed to pass through the EGR passage 43a.

An amount of exhaust gas to be recirculated to the intake system IN by the EGR device 43 (hereinafter referred to as “EGR gas amount”) is roughly determined by the exhaust gas pressure at a position upstream of the turbine of the turbocharger 5, the intake air pressure produced by the opening degree of the intake shutter valve 7, and an opening degree of the EGR valve 43b.

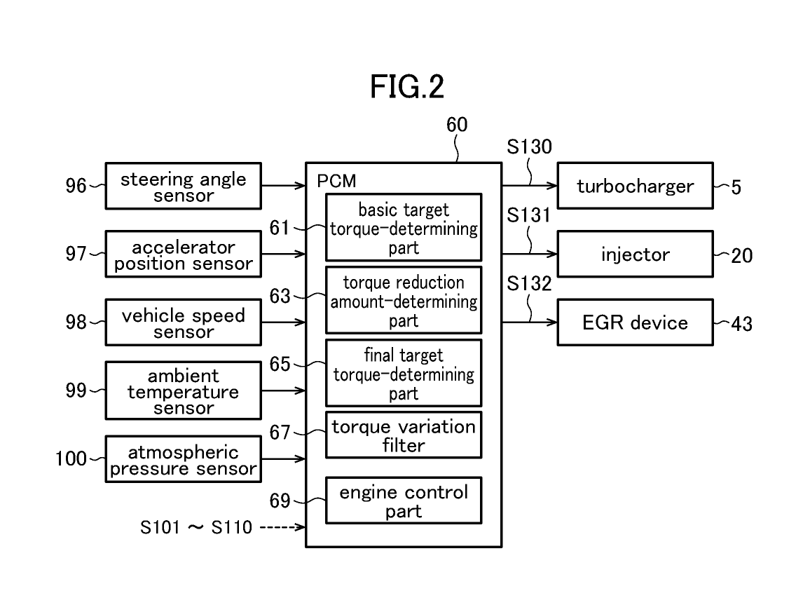

Next, with reference to FIG. 2, an electrical configuration of the turbocharged engine control device according to this embodiment will be described. FIG. 2 is a block diagram depicting the electrical configuration of the turbocharged engine control device according to this embodiment.

The PCM 60 (turbocharged engine control device) according to this embodiment is operable to output control signals S130 to S132 to perform respective controls for turbocharger 5, the fuel injection valve 20 and the EGR device 43, based on detection signals S96 to S100 output, respectively, from: a steering angle sensor 96 for detecting a rotational angle of a steering wheel of a vehicle mounting the engine (steering angle); an accelerator position sensor 97 for detecting an angular position of an accelerator pedal (accelerator position); a vehicle speed sensor 98 for detecting a vehicle speed; an ambient temperature sensor 99 for detecting an ambient temperature; and an atmospheric pressure sensor 100 for detecting atmospheric pressure, in addition to the detection signals S101 to S110 from the aforementioned various sensors 101 to 110.

The PCM 60 comprises: a basic target torque-determining part 61 configured to determine a basic target torque based on a driving state of the vehicle including manipulation of the accelerator pedal; a torque reduction amount-determining part 63 configured to determine a torque reduction amount based on a driving state of the vehicle other than the manipulation of the accelerator pedal; a final target torque-determining part 65 configured to determine a final target torque based on the basic target torque and the torque reduction amount; a torque variation filter 67 configured to smooth a temporal variation of the final target torque; and an engine control part 69 configured to control the engine body E to output the final target torque.

The above parts of the PCM 60 are realized by a computer which comprises: one or more CPUs; various programs (including a basic control program such as an OS, and an application program capable of being activated on the OS to realize a specific function) to be interpreted and executed by the CPU; and an internal memory such as ROM or RAM storing therein the programs and a variety of data.

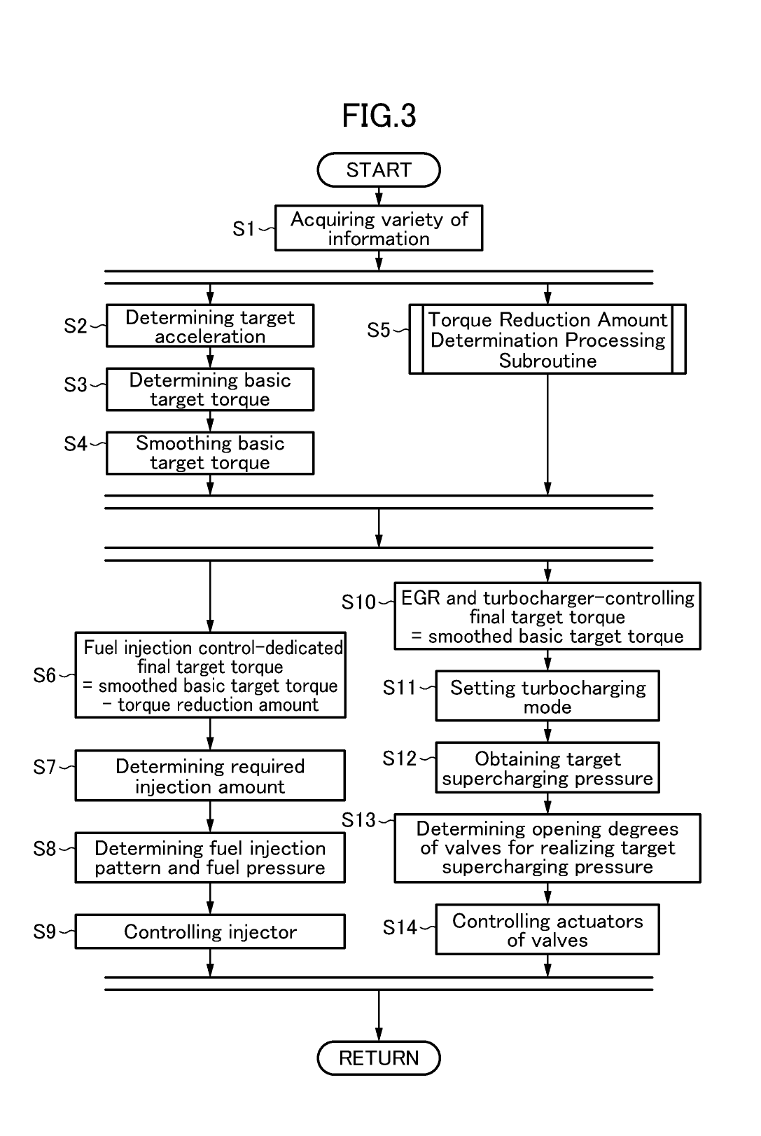

Next, with reference to FIGS. 3 to 6, processing to be performed by the turbocharged engine control device will be described.

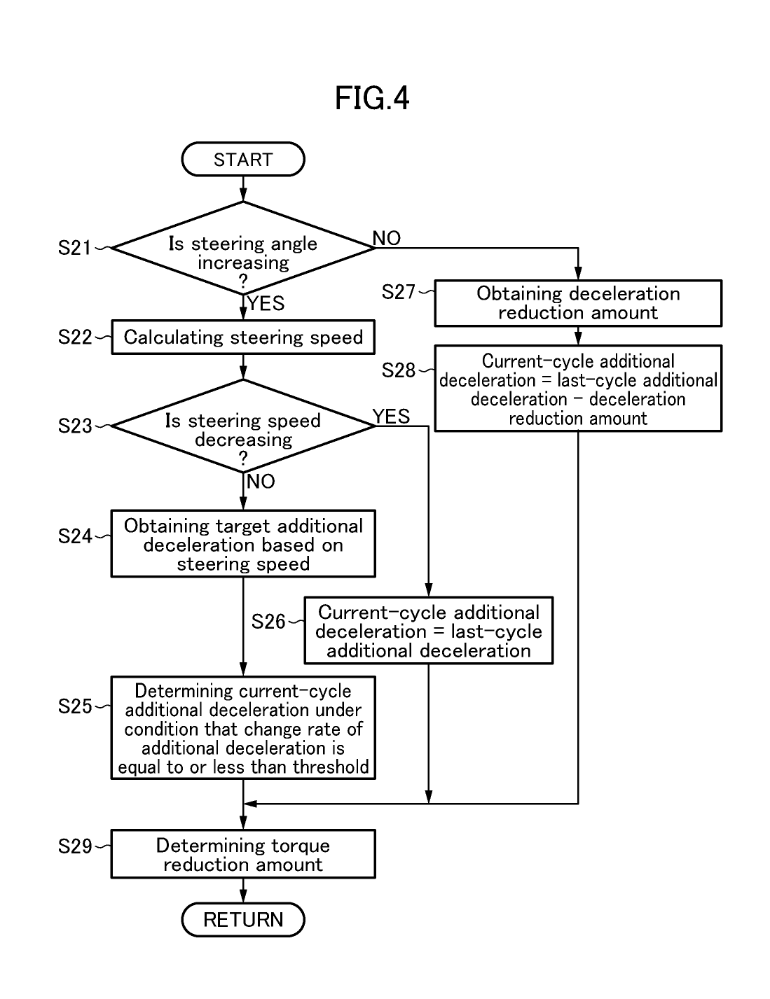

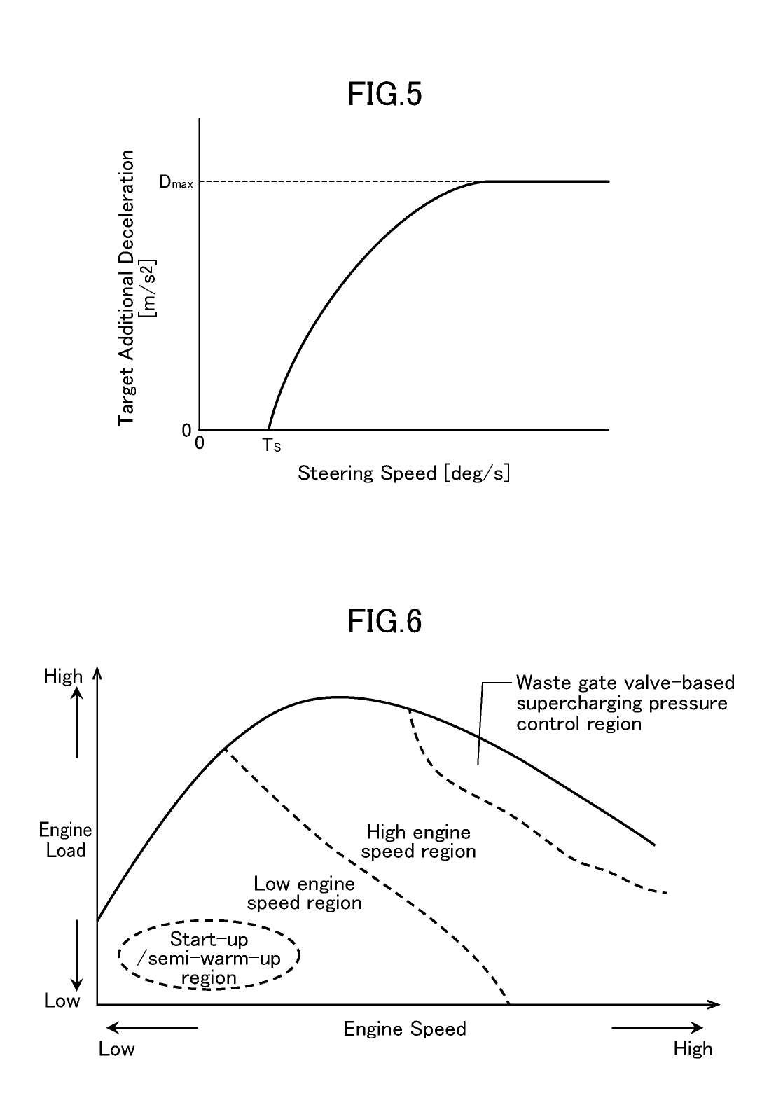

FIG. 3 is a flowchart of an engine control processing routine to be executed by the turbocharged engine control device according to this embodiment, so as to control the engine, and FIG. 4 is a flowchart of a torque reduction amount determination processing subroutine to be executed by the turbocharged engine control device according to this embodiment, so as to determine the torque reduction amount. FIG. 5 is a map presenting a relationship between steering speed, and additional deceleration to be determined by the turbocharged engine control device according to this embodiment, and FIG. 6 is a map conceptually presenting engine operation regions to be used by the turbocharged engine control device according to this embodiment, as criteria for switching among a plurality of supercharging modes using the large turbocharger 5a and the small turbocharger 5b.

The engine control processing routine in FIG. 3 is activated when an ignition switch of the vehicle is turned on to apply power to the turbocharged engine control device, and repeatedly executed.

As depicted in FIG. 3, upon start of the engine control processing routine, in step S1, the PCM 60 operates to acquire information about a driving state of the vehicle. Specifically, the PCM 60 operates to acquire, as the driving state, detection signals S96 to S110 and the like output from the aforementioned various sensors 96 to 110, including the steering angle detected by the steering angle sensor 96, the accelerator position detected by the accelerator position sensor 97, the vehicle speed detected by the vehicle speed sensor 98, and a gear stage currently set in a transmission of the vehicle.

Subsequently, in step S2, the basic target torque-determining part of the PCM 60 operates to set a target acceleration based on the driving state of the vehicle including the manipulation of the accelerator pedal acquired in the step S1. Specifically, the basic target torque-determining part operates to select, from a plurality of acceleration characteristic maps defined with respect to various vehicle speeds and various transmission gear stages (the maps are created in advance and stored in a memory or the like), one acceleration characteristic map corresponding to a current vehicle speed and a current transmission gear stage, and determine, as the target acceleration, an acceleration corresponding to a current accelerator position, with reference to the selected acceleration characteristic map.

Subsequently, in step S3, the basic target torque-determining part 61 operates to determine the basic target torque of the engine body E for realizing the target acceleration determined in the step S2. In this case, the basic target torque-determining part 61 operates to determine the basic target torque within a torque range which can be produced by the engine body E, based on current vehicle speed, transmission gear stage, road grade, road surface mu (μ), etc.

Subsequently, in step S4, the torque variation filter 67 operates to smooth a temporal variation of the basic target torque determined in the step S3. As a specific technique for the smoothing, it is possible to employ various known techniques (e.g., a technique of limiting a change rate of the basic target torque to a threshold or less, and a technique of calculating a moving average of the temporal variation of the basic target torque).

In parallel with the processings in the steps S2 and S4, in step S5, the torque reduction amount-determining part 63 operates to perform a torque reduction amount determination processing subroutine for determining the torque reduction amount based on the vehicle driving state other than the manipulation of the steering wheel. This torque reduction amount determination processing subroutine will be described with reference to FIG. 4.

As depicted in FIG. 4, upon start of the torque reduction amount determination processing subroutine, in step S21, the torque reduction amount-determining part 63 operates to determine whether or not an absolute value of the steering angle acquired in the step S1 is increasing. As a result, when the absolute value of the steering angle is increasing, the subroutine proceeds to step S22. In the step S22, the torque reduction amount-determining part 63 operates to calculate a steering speed based on the steering angle acquired in the step S1.

Subsequently, in step S23, the torque reduction amount-determining part 63 operates to determine whether or not an absolute value of the steering speed is decreasing.

As a result, when the absolute value of the steering speed is not decreasing, i.e., the absolute value of the steering speed is increasing or the absolute value of the steering speed does not change, the subroutine proceeds to step S24. In the step S24, the torque reduction amount-determining part 63 operates to obtain a target additional deceleration based on the calculated steering speed. This target additional deceleration is a deceleration to be added to the vehicle according to the manipulation of the steering wheel, so as to accurately realize vehicle behavior intended by a driver.

Specifically, the torque reduction amount-determining part 63 operates to obtain a value of the target additional deceleration corresponding to the steering speed calculated in the step S22, based on a relationship between the target additional deceleration and the steering speed, indicated by the map in FIG. 5.

In FIG. 5, the horizontal axis represents the steering speed, and the vertical axis represents the target additional deceleration. As depicted in FIG. 5, when the steering speed is less than a threshold T_{S} (e.g., 10 deg/s), a corresponding value of the target additional deceleration is 0. That is, when the steering speed is less than the threshold T_{S}, the control of adding deceleration to the vehicle according to the manipulation of the steering wheel is not performed.

On the other hand, when the steering speed is equal to or greater than the threshold T_{S}, a value of the target additional deceleration corresponding to this steering speed comes closer to a given upper limit value Dₘₐₓ (e.g., 1 m/s²). That is, as the steering speed becomes larger, the target additional deceleration becomes larger, and an increase rate of the target additional deceleration becomes smaller.

Subsequently, in the step S25, the torque reduction amount-determining part 63 operates to determine an additional deceleration in the current processing cycle (current-cycle additional deceleration), under the condition that the increase rate of the additional deceleration is equal to or less than a threshold Rₘₐₓ (e.g., 0.5 m/s³).

Specifically, the torque reduction amount-determining part 63 operates to, when an increase rate from the additional deceleration determined in the last processing cycle (last-cycle additional deceleration) to the target additional deceleration obtained in the step S24 in the current cycle is equal to or less than the threshold Rₘₐₓ, determine the target additional deceleration obtained in the step S24, as the current-cycle additional deceleration.

On the other hand, the torque reduction amount-determining part 63 operates to, when the increase rate from the last-cycle additional deceleration to the target deceleration obtained in the step S24 in the current processing cycle is greater than the threshold Rₘₐₓ, determine, as the current-cycle additional deceleration, a value obtained by increasing the last-cycle additional deceleration at the increase rate Rₘₐₓ for the given cycle period.

Referring to the step S23 again, when the absolute value of the steering speed is decreasing, the subroutine proceeds to step S26. In the step S26, the torque reduction amount-determining part 63 operates to determine the last-cycle additional deceleration as the current-cycle additional deceleration. That is, when the absolute value of the steering speed is decreasing, an additional deceleration corresponding to a maximum value of the steering speed (i.e., a maximum value of the additional deceleration) is maintained.

Referring to the step S21 again, when the absolute value of the steering angle is not increasing (i.e., is maintained constant or is decreasing), the subroutine proceeds to step S27. In the step S27, the torque reduction amount-determining part 63 operates to obtain an amount (deceleration reduction amount) by which the last-cycle additional deceleration is to be reduced in the current processing cycle. For example, the deceleration reduction amount may be calculated based on a constant reduction rate (e.g., 0.3 m/s³) preliminarily stored in a memory or the like. Alternatively, the deceleration reduction amount may be calculated based on a reduction rate determined according to the vehicle driving state acquired in the step S1 and/or the steering speed calculated in Step S22.

Subsequently, in step S28, the torque reduction amount-determining part 63 operates to determine the current-cycle additional deceleration by subtracting the deceleration reduction amount obtained in the step S27 from the last-cycle additional deceleration.

After completion of the step S25, S26 or S28, in step S29, the torque reduction amount-determining part 63 operates to determine the torque reduction amount, based on the current-cycle additional deceleration determined in the step S25, S26 or S28. Specifically, the torque reduction amount-determining part 63 operates to determine a value of the torque reduction amount required for realizing the current-cycle additional deceleration, based on the current vehicle speed, transmission gear stage, road grade and others acquired in the Step S1. After completion of the step S29, the torque reduction amount-determining part 63 operates to terminate the torque reduction amount determination processing subroutine, and the subroutine returns to the main routine.

Returning to FIG. 3, after completion of the processings in the steps S2 and S4 and the torque reduction amount determination processing subroutine in the step S5, in step S6, the final target torque-determining part 65 operates to subtract the torque reduction amount determined by the torque reduction amount determination processing subroutine in the step S5, from the basic target torque after being smoothed in the step S4, to thereby determine a fuel injection-controlling final target torque for controlling the fuel injection valve 20.

Subsequently, in step S7, the engine control part 69 operates to set a required injection amount to be injected from the fuel injection valve 20, based on the fuel injection-controlling final target torque set in the step S6, and the engine speed.

Then, in step S8, the engine control part 69 operates to set a fuel injection pattern and a fuel pressure, based on the required injection amount set in the step S7, and the engine speed.

Subsequently, in step S9, the engine control part 69 operates to control the fuel injection valve 20, based on the fuel injection pattern and the fuel pressure each set in the step S8.

In parallel with the processings in the steps S6 to S9, in step S10, the final target torque-determining part 65 operates to determine the basic target torque after being smoothed in the step S4, as an EGR and turbocharger-controlling final target torque for controlling the turbocharger 5 and the EGR device 43.

Subsequently, in step S11, the engine control part 69 operates to set a supercharging mode using the large turbocharger 5a and/or the small turbocharger 5b, based on the EGR and turbocharger-controlling final target torque set in the step S10, and the engine speed.

Specifically, the engine control part 69 operates to identify into which of a plurality of engine operation regions in a map depicted in FIG. 6 the EGR and turbocharger-controlling final target torque set in the step S10 and the engine speed fall, and set a supercharging mode preliminarily set in association with the identified engine operation region, as the supercharging mode using the large turbocharger 5a and/or the small turbocharger 5b.

For example, in a start-up/semi-warm-up region where both of the engine load (EGR and turbocharger-controlling final target torque) and the engine speed are relatively low, no supercharging by the large turbocharger 5a and/or the small turbocharger 5b is performed.

Further, in a low engine speed region where the engine speed is relatively low, except the start-up/semi-warm-up region, a two-stage supercharging mode using the large turbocharger 5a and the small turbocharger 5b is performed so as to efficiently perform supercharging even under low exhaust energy.

In a high engine speed region where the engine speed is relatively high, a single-stage supercharging mode using only the large turbocharger 5a is performed so as to efficiently supercharge a large amount of air while reducing intake resistance. In a waste gate valve-based supercharging pressure control region where the engine speed is relatively high, and the engine load is higher than that in the high engine speed region, the supercharging pressure of the large turbocharger 5a is adjusted by the waste gate valve 5e, so as to prevent the supercharging pressure from being excessively increased.

Returning to FIG. 3, after completion of the step S11, in step S12, the engine control part 69 operates to obtain a target supercharging pressure of the turbocharger 5. For example, a map presenting a relationship between the EGR and turbocharger-controlling final target torque and the target supercharging pressure is preliminarily stored in a memory or the like, and the engine control part 69 operates to obtain a value of the target supercharging pressure corresponding to the EGR and turbocharger-controlling final target torque set in the step S10, with reference to the map.

Subsequently, in step S13, the engine control part 69 operates to determine respective opening degrees of the compressor bypass valve 5c, the regulator valve 5d and the waste gate valve 5e, necessary for realizing the target supercharging pressure obtained in the step S12 under the supercharging mode using the large turbocharger 5a and/or the small turbocharger 5b, set in the step S11.

For example, when the engine body E is operated in the start-up/semi-warm-up region where no supercharging by the large turbocharger 5a and/or the small turbocharger 5b is performed, each of the compressor bypass valve 5c, the regulator valve 5d and the waste gate valve 5e is set to a fully-opened state.

Further, when the engine body E is operated in the low engine speed region where the two-stage supercharging mode using the large turbocharger 5a and the small turbocharger 5b is performed, each of the compressor bypass valve 5c and the waste gate valve 5e is set to a fully-closed state, and the regulator valve 5d is set to a given opening degree between fully-closed and fully-opened states, according to the target supercharging pressure.

When the engine body E is operated in the high engine speed region where the single-stage supercharging mode using only the large turbocharger 5a is performed, each of the compressor bypass valve 5c and the regulator valve 5d is set to the fully-opened state, and the waste gate valve 5e is set to a given opening degree between the fully-closed state and a partly-opened state, according to the target supercharging pressure.

When the engine body E is operated in the waste gate valve-based supercharging pressure control region where no supercharging is performed, or the single-stage supercharging mode using only the large turbocharger 5a is performed, each of the compressor bypass valve 5c and the regulator valve 5d is set to the fully-opened state, and the waste gate valve 5e is set to a given opening degree between the fully-closed and fully-opened states, according to the target supercharging pressure.

Subsequently, in step S14, the engine control part 69 operates to control respective actuators of the compressor bypass valve 5c, the regulator valve 5d and the waste gate valve 5e, based on the opening degrees set in the step S13.

In this case, along with controlling the actuators of the compressor bypass valve 5c, the regulator valve 5d and the waste gate valve 5e based on the opening degrees set in the step S13, the engine control part 69 operates to feedback-control the actuators so as to enable the supercharging pressure of the turbocharger 5 to come close to the target supercharging pressure obtained in the step S12. In the feedback control, the engine control part 69 operates to calculate the supercharging pressure of the turbocharger 5, based on the detection signals S103, S108, S109 from the intake air pressure sensors 103, 108 and the exhaust gas pressure sensor 109.

After completion of the steps S9 and S14, the PCM 60 terminates the engine control processing routine.

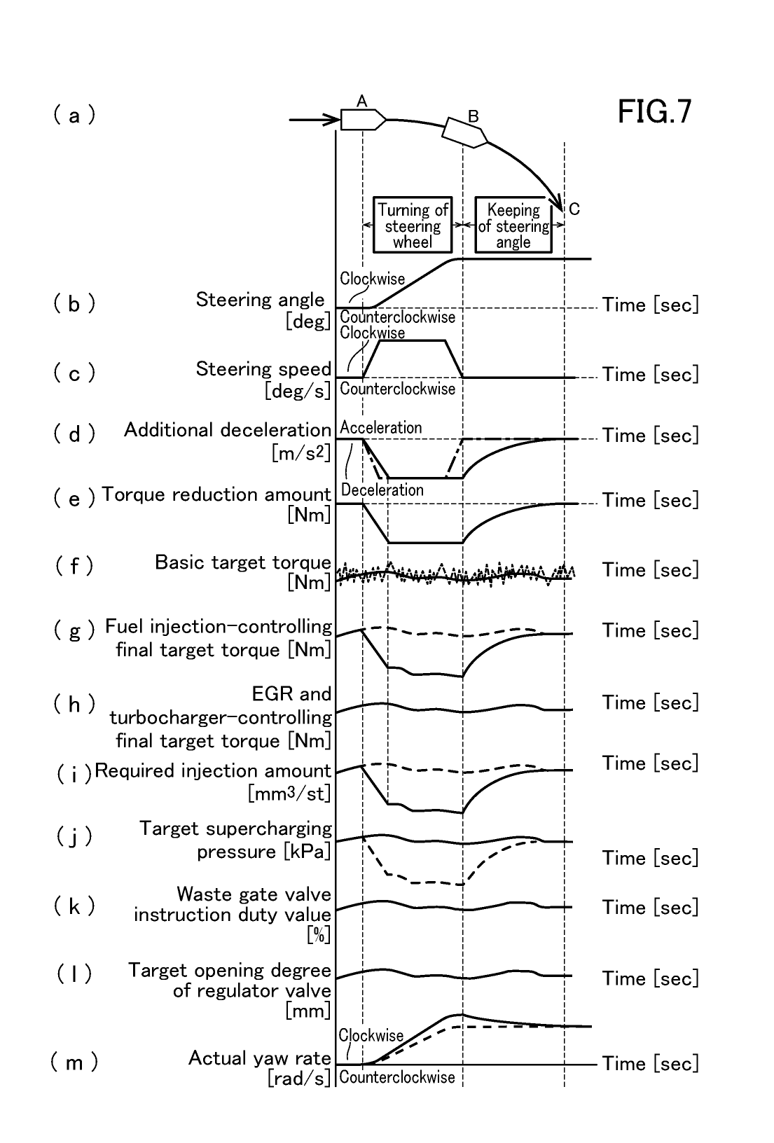

Next, with reference to FIG. 7, an operation of the turbocharged engine control device according to this embodiment will be described. FIG. 7 presents a temporal change in each parameter regarding engine control to be performed by the turbocharged engine control device according to this embodiment during turning of a vehicle equipped with the turbocharged engine control device.

Chart (a) is a top plan view schematically depicting the vehicle which is turning in a clockwise direction. As depicted in chart (a), the vehicle starts to turn from a position A, and continues to turn from a position B to a position C in the clockwise direction at a constant steering angle.

Chart (b) is a time chart presenting a change in the steering angle of the vehicle which is turning in the clockwise direction as depicted in chart (a). In chart (b), the horizontal axis represents time, and the vertical axis represents the steering angle. As presented in chart (b), clockwise steering is started at the position A, and then, along with additional turning manipulation of the steering wheel, a clockwise steering angle gradually increases and reaches a maximum value at the position B. Subsequently, the steering angle is maintained constant until the vehicle reaches the position C (Keeping of the steering angle).

Chart (c) is a time chart presenting a change in the steering speed of the vehicle which is turning in the clockwise direction as depicted in chart (a). In chart (c), the horizontal axis represents time, and the vertical axis represents the steering speed.

The steering speed of the vehicle is expressed as a temporal differentiation of the steering angle of the vehicle. That is, as presented in chart (c), when clockwise steering is started at the position A, a clockwise steering speed arises and is maintained approximately constant in an intermediate zone between the position A and the position B. Then, when the clockwise steering speed deceases, and the clockwise steering angle reaches the maximum value at the position B, the steering speed becomes 0. Then, when the clockwise steering angle is maintained during traveling from the position B to the position C, the steering speed is kept at 0.

Chart (d) is a time chart presenting a change in the additional deceleration determined based on the steering speed presented in chart (c). In chart (d), the horizontal axis represents time, and the vertical axis represents the additional deceleration. In chart (d), the solid line indicates a change in the additional deceleration determined in the torque reduction amount determination processing subroutine in FIG. 4, and the one-dot chain line indicates a change in the target additional deceleration based on the steering speed. As with the change in the steering speed presented in chart (c), the target additional deceleration indicated by the one-dot chain line starts to increase from the position A, and is maintained approximately constant in the intermediate zone between the position A and the position B, whereafter it decreases and becomes 0 at the position B.

As described with reference to FIG. 4, when the absolute value of the steering speed is determined in the step S23 to be not decreasing, i.e., to be increasing or to have no change, the torque reduction amount-determining part 63 operates in the step S24 to obtain the target additional deceleration based on the steering speed. Subsequently, in the step S25, the torque reduction amount-determining part 63 operates to determine an additional deceleration in each processing cycle, under the condition that the increase rate of the additional deceleration is equal to or less than the threshold Rₘₐₓ.

Chart (d) presents an example in which the increase rate of the target additional deceleration starting to increase from the position A is greater than the threshold Rₘₐₓ. In this case, the torque reduction amount-determining part 63 operates to increase the additional deceleration at an increase rate equal to the upper limit Rₘₐₓ (i.e., at an increase rate providing a gentler slope than that of the target additional deceleration indicated by the one-dot chain line). Then, when the target additional deceleration is maintained approximately constant in the intermediate zone between the position A and the position B, the torque reduction amount-determining part 63 operates to determine the additional deceleration such that it becomes equal to the target additional deceleration.

Then, when the absolute value of the steering speed is determined in the step S23 depicted in FIG. 4 to be decreasing, the torque reduction amount-determining part 63 operates to maintain the additional deceleration at the maximum steering speed, as mentioned above. Specifically, in chart (d), when the steering speed decreases toward the position B, the target additional deceleration indicated by the one-dot chain line also decreases along therewith, but the additional deceleration indicated by the solid line is maintained at its maximum value, until the vehicle reaches the position B.

On the other hand, when the absolute value of the steering angle is determined, in the step S21 depicted in FIG. 4, to be maintained constant or to be decreasing, the torque reduction amount-determining part 63 operates to obtain the deceleration reduction amount in the step S27, and reduce the additional deceleration by the obtained deceleration reduction amount, as mentioned above. In chart (d), the torque reduction amount-determining part 63 operates to reduce the additional deceleration to cause a reduction rate of the additional deceleration to become gradually smaller, i.e., to cause a slope of the solid line indicative of a change in the additional deceleration to become gradually gentler.

Chart (e) is a time chart presenting a change in the torque reduction amount determined based on the additional deceleration presented in chart (d). In chart (e), the horizontal axis represents time, and the vertical axis represents the torque reduction amount.

As mentioned above, the torque reduction amount-determining part 63 operates to determine a value of the torque reduction amount required for realizing the current-cycle additional deceleration, based on parameters such as current vehicle speed, transmission gear stage and road grade. Thus, in the case where respective values of these parameters are constant, the torque reduction amount is determined such that it changes in the same pattern as that of the additional deceleration presented in chart (d).

Chart (f) is a time chart presenting changes in the basic target torque before and after being smoothed by the torque variation filter 67. In chart (f), the horizontal axis represents time, and the vertical axis represents torque. Further, in chart (f), the dotted line indicates the basic target torque before being smoothed by the torque variation filter 67, and the solid line indicates the basic target torque after being smoothed by the torque variation filter 67.

The basic target torque determined so as to realize the target acceleration set based on current accelerator position, vehicle speed, transmission gear stage and others is likely to have a steep variation due to various disturbances or noises, as indicated by the dotted line in chart (f). By subjecting this basic target torque to smoothing using the torque variation filter 67, the steep variation is suppressed as indicated by the solid line in chart (f), and thus rapid acceleration and deceleration of the vehicle is suppressed.

Chart (g) is a time chart presenting a change in the fuel injection-controlling final target torque determined based on the basic target torque and the torque reduction amount. In chart (g), the horizontal axis represents time, and the vertical axis represents torque. Further, in chart (g), the dotted line indicates the smoothed basic target torque presented in chart (f), and the solid line indicates the fuel injection-controlling final target torque.

As described with reference to FIG. 3, the final target torque-determining part 65 operates to subtract the torque reduction amount determined by the torque reduction amount determination processing subroutine in the step S5, from the basic target torque after being smoothed in the step S4, to thereby determine the fuel injection-controlling final target torque. In the basic target torque and the torque reduction amount to be used for determining the final target torque, only the basic target torque determined based on the vehicle driving state including the manipulation of the accelerator pedal is subjected to smoothing using the torque variation filter 67. In other words, in regard to a part of a temporal variation of the final target torque corresponding to the torque reduction amount determined based on the manipulation of the steering wheel as the vehicle driving state other than the manipulation of the accelerator pedal, the torque reduction amount is not subjected to smoothing using the torque variation filter 67. Thus, as indicated by the solid line in chart (g), the torque reduction amount is directly reflected on the final target torque without being smoothed by the torque variation filter 67.

Chart (h) is a time chart presenting a change in the EGR and turbocharger-controlling final target torque determined based on the basic target torque. In chart (h), the horizontal axis represents time, and the vertical axis represents torque.

As described with reference to FIG. 3, the final target torque-determining part 65 operates to determine the basic target torque after being smoothed in the step S4, as the EGR and turbocharger-controlling final target torque for controlling the turbocharger 5, the EGR device 43 and a low-pressure EGR device 48. Thus, as presented in chart (h), the EGR and turbocharger-controlling final target torque temporally changes in the same pattern as that of the temporal change in the smoothed basic target torque.

Chart (i) is a time chart presenting a change in the required fuel injection amount determined based on the fuel injection-controlling final target torque. In chart (i), the horizontal axis represents time, and the vertical axis represents the required fuel injection amount. Further, in chart (i), the dotted line indicates the required fuel injection amount corresponding to the smoothed basic target torque presented in chart (f), and the solid line indicates the required injection amount corresponding to the fuel injection-controlling final target torque presented in chart (g).

In the example in chart (i), the engine control part 69 operates to control, by a fuel injection amount to be injected from the fuel injection valve 20, a part of a temporal variation of the fuel injection-controlling final target torque set in the step S6, corresponding to the torque reduction amount. Thus, as indicated by the solid line in chart (i), the required fuel injection amount temporally changes in the same pattern as that of the fuel injection-controlling final target torque presented in chart (g)

Chart (j) is a time chart presenting a change in the target supercharging pressure determined based on the EGR and turbocharger-controlling final target torque. In chart (j), the horizontal axis represents time, and the vertical axis represents the target supercharging pressure. Further, in chart (j), the solid line indicates the target supercharging pressure determined based on the EGR and turbocharger-controlling final target torque presented in chart (h), and the dotted line indicates the target supercharging pressure determined based on the fuel injection-controlling final target torque presented in chart (g).

Supposing that the target supercharging pressure is determined based on the fuel injection-controlling final target torque, the target supercharging pressure changes according to the torque reduction amount, as indicated by the dotted line in chart (j). However, in this embodiment, the EGR and turbocharger-controlling final target torque does not reflect any change in the torque reduction amount, so that it temporally changes in the same pattern as that of the smoothed basic target torque, as presented in chart (h). Thus, the target supercharging pressure set based on the EGR and turbocharger-controlling final target torque temporally changes in the same pattern as that of the smoothed basic target torque, without changing according to the torque reduction amount.

Chart (k) is a time chart presenting a change in the instruction duty value for the actuator of the waste gate valve 5e, in the case where the target supercharging pressure changes as presented in chart (j). In chart (k), the horizontal axis represents time, and the vertical axis represents the instruction duty value for the actuator of the waste gate valve 5e. For example, the actuator of the waste gate valve 5e is composed of a solenoid actuator configured to be driven under PWM control, and is configured to gradually reduce the opening degree of the waste gate valve 5e as the instruction duty value becomes higher, to thereby cause a rise in the supercharging pressure.

The target supercharging pressure temporally changes in the same pattern as that of the smoothed basic target torque, as presented in chart (j), so that the waste gate valve actuator instruction duty value determined based on the target supercharging pressure also temporally changes in the same pattern as that of the smoothed basic target torque, without changing according to the torque reduction amount.

Chart (l) is a time chart presenting a change in target opening degree of the regulator value 5d in the case where the target supercharging pressure changes as presented in chart (j). In chart (l), the horizontal axis represents time, and the vertical axis represents the target opening degree of the regulator value 5d. In the case where supercharging by the large turbocharger 5a is performed, as the opening degree of the regulator valve 5d becomes larger, an amount of exhaust gas supplied to the turbine of the large turbocharger 5a is gradually increased, thereby causing a gradual rise in the supercharging pressure.

The target supercharging pressure temporally changes in the same pattern as that of the smoothed basic target torque, as presented in chart (j), so that the opening degree of the regulator valve 5d determined based on the target supercharging pressure also temporally changes in the same pattern as that of the smoothed basic target torque, without changing according to the torque reduction amount.

As above, it is restricted to control the turbocharger 5 such that the supercharging pressure thereof is lowered according to an increase in the torque reduction amount, so that it is possible to prevent the supercharging pressure from being lowered when the torque reduction amount is increased. Thus, after that, when the target torque is instantaneously raised, it is possible to cause a rise in the supercharging pressure with high responsivity with respect to the rise in the target torque.

Chart (m) is a time chart presenting a change in yaw rate (actual yaw rate) generated in the vehicle being steered as presented in chart (b), when the fuel injection amount is controlled based on the fuel injection-controlling final target torque presented in chart (i), and a change in actual yaw rate generated in the vehicle when control corresponding to the torque reduction amount presented in chart (e) is not performed (i.e., control of the fuel injection amount is performed based on the smoothed basic target torque indicated by the dotted line in chart (g)). In chart (m), the horizontal axis represents time, and the vertical axis represents yaw rate. Further, in chart (m), the solid line indicates a change in the actual yaw rate when the control of the fuel injection amount is performed based on the fuel injection-controlling final target torque, and the dotted line indicates a change in the actual yaw rate when the control corresponding to the torque reduction amount is not performed.

After clockwise steering is started at the position A, when the torque reduction amount is increased as presented in chart (e) along with an increase in clockwise steering speed, a load applied to the front road wheels as steerable road wheels of the vehicle is increased. As a result, a frictional force between each of the front road wheels and a road surface is increased, and a cornering force of the front road wheels is increased, thereby providing an improved turn-in ability of the vehicle. That is, as depicted in chart (m), in the intermediate zone between the position A and the position B, when the control of the fuel injection amount is performed based on the fuel injection-controlling final target torque reflecting the torque reduction amount (solid line), a larger clockwise (CW) yaw rate is generated in the vehicle, as compared to the case where the control corresponding to the torque reduction amount is not performed (dotted line).

In addition, as depicted in charts (d) and (e), when the steering speed is gradually reduced toward the position B, the torque reduction amount is maintained at its maximum value, although the target additional deceleration is reduced, so that it is possible to maintain the load applied to the front road wheels and keep up the turn-in ability of the vehicle, as long as the tuning of the steering wheel is continued.

Further, when the absolute value of the steering angle is maintained constant during traveling from the position B to the position C, the torque reduction amount is smoothly reduced. Thus, in response to completion of the turning of the steering wheel, the load applied to the front road wheels can be gradually reduced to gradually reduce the cornering force of the front road wheels, thereby restoring the output torque of the engine body E, while stabilizing a vehicle body.

Next, some modifications of the above embodiment will be described.

Although the above embodiment has been described based on an example in which the torque reduction amount-determining part 63 is configured to obtain the target additional deceleration based on the steering speed, and determine the torque reduction amount based on the obtained target additional deceleration, the torque reduction amount-determining part 63 may be configured to determine the torque reduction amount based on any driving state of the vehicle other than the manipulation of the accelerator pedal (e.g., steering angle, yaw rate, or slip ratio).

For example, the torque reduction amount-determining part 63 may be configured to calculate a target yaw acceleration to be generated in the vehicle, based on a target yaw rate calculated from the steering angle and the vehicle speed, and a yaw rate input from a yaw rate sensor, and obtain the target additional deceleration based on the calculated target yaw acceleration to determine the torque reduction amount. Alternatively, a lateral acceleration generated along with turning of the vehicle may be detected by an acceleration sensor, and the torque reduction amount may be determined based on the determined lateral acceleration. Alternatively, the torque reduction amount-determining part 63 may be configured to determine the torque reduction amount, based on any demand different from the target additional deceleration (e.g., a torque required for cancelling out vibration of a powertrain during acceleration/deceleration).

Although the above embodiment has been described based on an example in which the engine control part 69 is configured to control the turbocharger 5 based on the EGR and turbocharger-controlling final target torque which does not reflect the torque reduction amount (i.e., based on the smoothed basic target torque), the engine control part 69 may be configured to control the turbocharger 5 based on an EGR and turbocharger-controlling final target torque reflecting the torque reduction amount.

In this case, the engine control part 69 is configured to restrict controlling the turbocharger 5 according to a change in the final target torque corresponding to a change in the torque reduction amount. For example, the final target torque-determining part 65 may be configured to, in the step S10 of the engine control processing routine depicted in FIG. 3, multiply the torque reduction amount determined in the torque reduction amount determination processing subroutine in the step S5 by a correction coefficient of less than 1 to obtain a corrected torque reduction amount, and then subtract the corrected torque reduction amount from the basic target torque after being smoothed in the step S4, to thereby determine an EGR and turbocharger-controlling final target torque for controlling the turbocharger 5 and the EGR device 43. In the EGR and turbocharger-controlling final target torque determined in this manner, a change in the final target torque corresponding to a change in the torque reduction amount is reduced, as compared to the fuel injection-controlling final target torque obtained by directly subtracting the torque reduction amount from the basic target torque, so that it is restricted to control the turbocharger 5 according to a change in the final target torque corresponding to a change in the torque reduction amount.

Although the above embodiment has been described based on an example in which the turbocharger 5 is constructed as the two-stage supercharging system comprising the large turbocharger 5a and the small turbocharger 5b, the turbocharger 5 may be constructed as a variable geometry turbocharger (VGT) comprising a plurality of movable flaps provided to surround the entire circumference of a turbine, wherein a cross-sectional flow area (cross-sectional nozzle area) with respect to the turbine can be changed by the movable flaps. In this case, the engine control part 69 may be configured to control an opening degree of the flaps, based on the target supercharging pressure.

Although the above embodiment has been described based on an example where the engine 200 employing the turbocharged engine control device comprises the engine body E designed as a diesel engine, the turbocharged engine control device according to the present invention may be applied to an engine 200 equipped with a gasoline engine comprising an air-amount regulating device for regulating an amount of air to be introduced into a cylinder, and an ignition device for igniting an air-fuel mixture in the cylinder. In this case, the engine control part 69 may be configured to control the air-amount regulating device (e.g., a throttle valve actuator, or a variable valve timing mechanism) to regulate the amount of air to be introduced into the cylinder and/or control the ignition device to regulate an ignition timing, so as to enable the gasoline engine to output the final target torque.

Next, advantageous effects of the turbocharged engine control device according to each of the above embodiment and the modifications of the embodiment will be described.

First of all, the engine control part 69 is configured to control the engine body E to output the fuel injection-controlling final target torque reflecting the torque reduction amount determined based on the vehicle driving state other than the manipulation of the accelerator pedal, so that it is possible to control the engine body E to obtain the torque reduction amount with high responsivity with respect to the vehicle driving state other than the manipulation of the accelerator pedal, to thereby quickly apply a load to front road wheels. This makes it possible to control the engine body E to accurately realize vehicle behavior intended by a driver.

Further, the engine control part 69 is configured to restrict controlling the turbocharger 5 according to a change in the final target torque corresponding to a change in the torque reduction amount, so that it is possible to prevent a situation where the supercharging pressure is lowered by controlling the turbocharger 5 according to an instantaneous change in the fuel injection-controlling final target torque directly or fully reflecting the torque reduction amount. Thus, after that, when the reduced target torque is instantaneously raised, it is possible to cause a rise in the supercharging pressure with high responsivity with respect to the rise in the target torque. This makes it possible to suppress deterioration in acceleration response.

In particular, the engine control part 69 is configured to control the turbocharger 5 based on a state of the engine body E (target supercharging pressure) in which the engine body E is operated to output the EGR and turbocharger-controlling final target torque which does not reflect the torque reduction amount (i.e., the smoothed basic target torque), so that it is possible to prevent the situation where the supercharging pressure is lowered by controlling the turbocharger 5 according to an instantaneous change in the fuel injection-controlling final target torque reflecting the torque reduction amount, and thus suppress deterioration in acceleration response.

Further, the torque reduction amount-determining part 63 is configured to determine the torque reduction amount according to the manipulation of the steering wheel of the vehicle. Thus, a temporal change in the torque reduction amount determined based on the manipulation of the steering wheel can be reflected on a temporal change in the final target torque, so that it is possible to quickly add, to the vehicle, deceleration according to the manipulation of the steering wheel by a driver to thereby apply a load to front road wheels to quickly increase a cornering force, thereby improving responsivity with respect to the manipulation of the steering wheel. This makes it possible to control the engine body E to accurately realize vehicle behavior intended by the driver, while suppressing deterioration in acceleration response.

In particular, the torque reduction amount-determining part 63 is configured to determine the torque reduction amount such that, as the steering speed of the vehicle becomes larger, the torque reduction amount is gradually increased, and an increase rate of the torque reduction amount is gradually reduced. Thus, when the steering speed of the vehicle starts increasing after start of steering of the vehicle, the torque reduction amount can be quickly increased, so that it is possible to quickly add deceleration to the vehicle at the start of steering of the vehicle to quickly apply a sufficient load to front road wheels as steerable road wheels. This can cause an increase in frictional force between each of the front road wheels as steerable road wheels and a road surface and thus an increase in cornering force of the front road wheels, thereby providing an improved turn-in ability of the vehicle in an initial phase after entering a curve, and an improved responsivity with respect to turning manipulation of the steering wheel, while suppressing deterioration in acceleration response.

Further, the basic target torque-determining part 61 is configured to determine the target acceleration of the vehicle based on the driving state of the vehicle including the manipulation of the accelerator pedal, and then determine the basic target torque based on the target acceleration. Thus, the basic target torque is determined based on the target acceleration, so that it becomes possible to control the engine body E to accurately realize acceleration intended by a driver, while suppressing deterioration in acceleration response.

Further, in the above embodiment, the turbocharged engine control device is applied to a diesel engine. Thus, by changing the fuel injection amount of the diesel engine according to the fuel injection-controlling final target torque reflecting the torque reduction amount, it becomes possible to accurately realize a temporal change in the torque reduction amount determined based on the vehicle driving state other than the manipulation of the accelerator pedal, with high responsivity. This makes it possible to control the diesel engine to accurately realize vehicle behavior intended by a driver.

Alternatively, the turbocharged engine control device may be applied to a gasoline engine comprising the air-amount regulating device for regulating an air amount to be introduced into a cylinder, and the ignition device for igniting an air-fuel mixture in the cylinder, wherein the engine control part 69 is configured to control the air-amount regulating device to regulate the air amount to be introduced into the cylinder and/or control the ignition device to regulate an ignition timing, so as to enable the gasoline engine to output the final target torque. Thus, by changing the air amount to be introduced into the cylinder and/or the ignition timing, it becomes possible to accurately realize a temporal change in the torque reduction amount determined based on the vehicle driving state other than the manipulation of the accelerator pedal, with high responsivity. This makes it possible to control the gasoline engine to accurately realize vehicle behavior intended by a driver.

### LIST OF REFERENCE SIGNS

1: intake passage
5: turbocharger
5a: large turbocharger
5b: small turbocharger
5c: compressor bypass valve
5d: regulator valve
5e: waste gate valve
20: injector
41: exhaust passage
43: EGR device
60: PCM
61: basic target torque-determining part
63: torque reduction amount-determining part
65: final target torque-determining part
67: torque variation filter
69: engine control part
200: engine system
E: engine body

What is claimed is:

1. A turbocharged engine control device for controlling an engine comprising at least a turbocharger, based on a driving state of a vehicle mounting the engine, comprising:
a basic target torque-determining part configured to determine a basic target torque based on a driving state of the vehicle including manipulation of an accelerator pedal;
a torque reduction amount-determining part configured to determine a torque reduction amount based on a driving state of the vehicle other than the manipulation of the accelerator pedal;
a final target torque-determining part configured to determine a final target torque based on the basic target torque and the torque reduction amount; and
an engine control part configured to control the engine to output the final target torque and configured to control the turbocharger based on the final target torque,
wherein the engine control part is configured to restrict controlling the turbocharger according to a change in the final target torque corresponding to a change in the torque reduction amount.

2. The turbocharged engine control device as recited in claim 1, wherein the engine control part is configured to control the turbocharger based on a state of the engine in which the engine is operated to output the basic target torque.

3. The turbocharged engine control device as recited in claim 1, wherein the torque reduction amount-determining part is configured to determine the torque reduction amount according to manipulation of a steering wheel of the vehicle.

4. The turbocharged engine control device as recited in claim 3, wherein the torque reduction amount-determining part is configured to determine the torque reduction amount such that, as a steering speed of the vehicle becomes larger, the torque reduction amount is gradually increased, and an increase rate of the torque reduction amount is gradually reduced.

5. The turbocharged engine control device as recited in claim 1, wherein the basic target torque-determining part is configured to determine a target acceleration of the vehicle based on the driving state of the vehicle including the manipulation of the accelerator pedal, and then determine the basic target torque based on the target acceleration.

6. The turbocharged engine control device as recited in claim 1, wherein the engine is a diesel engine comprising a fuel injection device for injecting fuel into a cylinder, and wherein the engine control part is configured to control the fuel injection device to regulate a fuel injection amount so as to enable the diesel engine to output the final target torque.

7. The turbocharged engine control device as recited in claim 1, wherein the engine is a gasoline engine comprising an air-amount regulating device for regulating an amount of air to be introduced into a cylinder, and an ignition device for igniting an air-fuel mixture in the cylinder, and wherein the engine control part is configured to control the air-amount regulating device to regulate the amount of air to be introduced into the cylinder and/or control the ignition device to regulate an ignition timing, so as to enable the gasoline engine to output the final target torque.
